(19) United States
(12) Patent Application Publication
(10) Pub. No.: US 2009/0181061 A1
(43) Pub. Date: Jul. 16, 2009

(54) Microbial Resistant Composites

(76) Inventors: Neil Granlund, Columbia Heights, MN (US); Jeffrey Jacob Cernohous, Hudson, WI (US)

Correspondence Address: HOLLAND & HART LLP, 60 E. South Temple, Suite 2000, P.O. Box 11583, Salt Lake City, UT, 84110, US

(21) Appl. No.: 12/324,603

(22) Filed: Nov. 26, 2008

Related U.S. Application Data
(63) Continuation-in-part of application No. PCT/US2007/068979, filed on May 15, 2007.
(60) Provisional application No. 60/803,322, filed on May 26, 2006.

(51) Int. Cl. A01N 65/00; A01N 25/00; A01N 31/06

(52) U.S. Cl. 424/405; 424/775; 514/182

(57) ABSTRACT

Microbial resistant composites and methods for providing microbial resistant composites are described herein. The microbial resistant composites may include a polymeric material in the form of a polymeric matrix and a naturally occurring antimicrobial material such as the bark from aspen trees, birch trees, poplar trees, and extracts thereof. The microbial resistant composite may be prepared by adding the tree bark to a polymeric matrix and a filler (e.g., cellulosic material such as wood fiber) to enhance the microbial resistance of the composite.

### CROSS-REFERENCE TO RELATED PATENT APPLICATIONS

This application is a continuation-in-part of International Application Number PCT/US2007/068979, entitled “Microbial Resistant Composites,” filed on 15 May 2007, which claims priority to U.S. Provisional Patent Application No. 60/803,322, entitled “Compositions and Methods for Producing Microbial Resistant Composites,” filed on 26 May 2006, all of which are hereby incorporated by reference herein in their entireties. U.S. patent application Ser. No. 11/284,414, entitled “Foaming Additives,” filed on 21 Nov. 2005, and U.S. patent application Ser. No. 11/420,215, entitled “Additives for Foaming Polymeric Materials,” filed on 24 May 2006, are hereby incorporated by reference herein in their entireties. In the event of a conflict, the subject matter explicitly recited or shown herein controls over any subject matter incorporated by reference. All definitions of a term (express or implied) contained in any of the subject matter incorporated by reference herein are hereby disclaimed. The closing paragraphs of this specification dictate the meaning to be given to any term explicitly recited herein subject to the disclaimer in the preceding sentence.

### BACKGROUND

Wood plastic composites (WPCs) are composite materials that include a cellulosic material such as wood particles, and a plastic material such as polyethylene, polypropylene, polyvinyl chloride, etc. WPCs have found widespread use as outdoor deck floors. WPCs have also been used to form railings, fences, landscaping timbers, cladding and siding, park benches, molding and trim, window and door frames, and/or indoor furniture. WPCs are more environmentally friendly and require less maintenance than other alternatives such as solid wood treated with preservatives or solid wood made from a rot-resistant wood species (e.g., redwood, etc.). WPCs are resistant to cracking and splitting and can be molded with or without simulated wood grain details.

Although WPCs are more resistant to rot and decay than solid wood, WPCs still contain cellulosic material that is subject to rot. In particular, WPCs may be subject to fungi that cause white rot, brown rot, etc. In the past, materials such as zinc borate have been added to WPCs to make the WPCs resistant to the microbes that cause rot and decay. Although these materials have proven somewhat effective, they are toxic and are known to leach from the composite into the environment. Also, these materials add significantly to the cost of the composite formulations. Accordingly, it would be desirable to provide a material that is capable of inhibiting microbial growth associated with WPCs.

Melt processable polymeric materials, hereinafter referred to as polymeric matrices, are often combined with certain fillers and/or additives to both enhance the economics and to impart desired physical characteristics to the processed material. The fillers may include various organic material or inorganic material mixed throughout the polymeric host material. For example, wood flour or wood fibers are often included with certain hydrocarbon polymers to make a composite that is suitable as a structural building material upon melt processing.

### SUMMARY

The subject matter described herein relates to compositions and methods for producing microbial resistant composites. The microbial resistant composites may include polymeric material and naturally occurring antimicrobial material. The polymeric material may be a thermoplastic. The polymeric material may include polyolefin material such as polypropylene and/or polyethylene. The antimicrobial materials may include extracts of natural materials such as tree bark. For example, antimicrobial materials may be extracted from any suitable tree bark that contains such materials such as aspen bark, birch bark, poplar bark, and the like. The extracts may be combined together in any suitable formulation and added to a polymeric matrix to render the resulting composite antimicrobial resistant.

The microbial resistant composite may include a filler such as a cellulosic material. In one embodiment, the cellulosic material may be a fibrous material. In another embodiment, the cellulosic material may be wood flour and/or wood fiber. The use of naturally occurring antimicrobial materials may have particularly utility in polymers filled with high levels of a cellulosic material such as wood plastic composites (WPC).

The microbial resistant composites may be produced using melt processing techniques. Typically, such processes include melt processing polymeric materials with naturally occurring antimicrobial materials. Examples of suitable melt processes that may be used include extrusion, injection molding, blow molding, rotomolding, and batch mixing.

For purposes of this document, the following terms used are defined as follows: “Antimicrobial Material” means a material that, when incorporated into a polymer matrix slows or eliminates microbial growth on articles produced therefrom (e.g., mold and mildew). “Polymeric Matrix” means a matrix of one or more melt processable polymeric materials. “Melt Processable Composition” means a formulation capable of being melt processed, typically at elevated temperatures, by means of a conventional polymer processing technique such as extrusion or injection molding as an example. “Filler” means an organic or inorganic material that does not possess viscoelastic characteristics under the conditions utilized to melt process the filled polymeric matrix. “Cellulosic Material” means natural or man-made materials derived from cellulose. Cellulosic materials include for example: wood flour, wood fibers, sawdust, wood shavings, newsprint, paper, flax, hemp, grain hulls, kenaf, jute, sisal, nut shells or combinations thereof.

The foregoing and other features, utilities, and advantages of the subject matter described herein will be apparent from the following more particular description of certain embodiments as illustrated in the accompanying drawings.

### DETAILED DESCRIPTION

Microbial resistant composites may include a polymeric material that forms a matrix and a naturally occurring antimicrobial material. The antimicrobial material may be obtained from a natural material such as tree bark. For example, antimicrobial material may be obtained from bark obtained from aspen, birch and/or poplar trees. Such materials are typically considered scrap or waste streams in the lumber production process, and are relatively low cost as a result. In a preferred embodiment, betulin (as used herein betulin refers to the pure compound as well as related compounds such as betulinic acid) or other triterpenes related materials are utilized as the antimicrobial material and have been found to produce composite formulations that possess excellent antimicrobial resistance. Preferably, the betulin is extracted from a natural material such as birch bark. However, it should be appreciated that synthetic betulin may also be used.

The amount of antimicrobial material present in the melt processable composition is dependent upon several variables, such as for example, the polymeric matrix, the type and amount of filler, the type of melt processing equipment, the processing conditions, and others. It should be appreciated that an appropriate amount of antimicrobial material should be used to achieve the desired microbial resistance in the resulting polymeric material. In one embodiment, the microbial resistant composite includes about 0.05 to 10.0 wt. % of the naturally occurring antimicrobial material, or desirably about 0.5 to 5.0 wt. % of the naturally occurring antimicrobial material.

The microbial resistant composite material may include numerous additional additives. The additives may be added to the melt processable composition that is processed to form the microbial resistant composite. Non-limiting examples of suitable additives include antioxidants, light stabilizers, fibers, antiblocking agents, heat stabilizers, impact modifiers, biocides, compatibilizers, flame retardants, plasticizers, tackifiers, colorants, processing aids, lubricants, coupling agents, and pigments. The additives may be incorporated into the melt processable composition in the form of powders, pellets, granules, or in any other extrudable form. The amount and type of conventional additives in the melt processable composition may vary depending upon the polymeric matrix and the desired physical properties of the finished composition.

It should be appreciated that the microbial resistant composite material may include any of a number of suitable polymeric materials suitable for melt processing. The polymeric materials may be either hydrocarbon or non-hydrocarbon polymers. In one embodiment, the polymeric matrix is an olefin-based polymer. The polymeric materials (if more than one is used, it being understood that a single polymeric material may be used) combine to form a polymeric matrix that is melt processed to form the microbial resistant composite material.

The polymeric matrix is a primary component of the melt processable composition. A wide variety of polymers suitable for melt processing may form a part or all of the polymeric matrix. The polymeric matrix may also include polymers that are sometimes referred to as being difficult to melt process, especially when combined with an interfering element. They include both hydrocarbon and non-hydrocarbon polymers. Examples of suitable polymeric materials include, but are not limited to, polyamides, polyimides, polyurethanes, polyolefins, polystyrenes, polyesters, polycarbonates, polyketones, polyureas, polyvinyl resins, polyacrylates and polymethylacrylates.

In one embodiment, the polymeric matrix may include polymeric materials such as, high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polyvinyichioride (PVC), fluoropolymers, Liquid Crystal Polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters or combinations thereof. In one embodiment, the polymeric matrix may include polyolefins.

Polymeric materials that are derived from recycled plastics may also be desirable since they often cost little to obtain. However, such materials are often derived from materials coming from multiple waste streams having vastly different melt rheologies. This can make the material very problematic to process. The processing of such materials with interfering elements can be even more problematic. The additives described herein may allow the use of polymeric materials obtained from recycled plastics, which would allow very low cost, filled recycled plastics to be converted into useful products instead of being landfilled.

The microbial resistant composites may include at least about 30 wt. % of polymeric matrix. It should be appreciated that the amount of polymeric matrix in the microbial resistant composite may vary depending upon, for example, the type of polymer, the type of fillers, the processing equipment, processing conditions and the desired end product.

In one embodiment, the polymeric matrix may include blends of various thermoplastic polymers. Additives such as antioxidants, light stabilizers, fillers, fibers, antiblocking agents, heat stabilizers, impact modifiers, biocides, compatibilizers, flame retardants, plasticizers, tackifiers, colorants, and pigments may be added to the polymeric matrix to form a melt processable composition. The polymeric materials and/or the polymeric matrix may be incorporated into the melt processable composition in the form of powders, pellets, granules, or in any other extrudable form.

The microbial resistant composites may include any suitable filler such as those that are commonly utilized as fillers or additives in the polymer composite industry. Suitable examples of interfering elements include talc, mica, glass fiber, alumina, silica, carbon fibers, anti-block agents, glass fibers, carbon black, aluminum oxide, and cellulosic materials.

The amount of the filler in the melt processable composition may vary depending upon the polymeric matrix and the desired physical properties of the finished composition. The appropriate amount of filler should be selected to match with a specific polymeric matrix in order to achieve desired physical properties of the finished material. Typically, the microbial resistant composite may include no more than about 80 wt. % filler or about 70 wt. % filler. In another embodiment, the microbial resistant composite may include at least about 30 wt. % filler, about 40 wt. % filler, or, desirably, at least about 50 wt. % filler. Additionally, the filler may be provided in various forms depending on the specific polymeric matrices and end use applications.

In one embodiment, the microbial resistant composite includes a cellulosic material that serves as the filler. Cellulosic materials are commonly utilized in melt processable compositions to impart specific physical characteristics or to reduce the cost of the finished composition. Cellulosic materials generally include natural or wood based materials having various aspect ratios, chemical compositions, densities, and physical characteristics. Non-limiting examples of cellulosic materials include wood flour, wood fibers, sawdust, wood shavings, newsprint, paper, flax, hemp, rice hulls, kenaf, jute, sisal, peanut shells. Such composites have found extensive application and use as building materials. Combinations of cellulosic materials, or cellulosic materials with other fillers or additives, may also be used in the melt processable composition.

The melt processable composition may be prepared using any of a variety of methods. For example, the polymeric matrix and the antimicrobial material can be combined together by any of the blending techniques usually employed in the plastics industry, such as with a compounding mill, a Banbury mixer, or a mixing extruder in which the antimicrobial material is uniformly distributed throughout the host polymer. The antimicrobial material and the host polymer may be used in the form, for example, of a powder, a pellet, or a granular product. The mixing operation is most conveniently carried out at a temperature above the melting point or softening point of the polymeric matrix. However, it is also feasible to dry-blend the components in the solid state as particulates and then cause uniform distribution of the components by feeding the dry blend to a twin-screw melt extruder. The resulting melt-blended mixture can be either extruded directly into the form of the final product shape or pelletized or otherwise comminuted into a desired particulate size or size distribution and fed to an extruder, which typically will be a single-screw extruder, that melt-processes the blended mixture to form the final product shape.

Melt-processing typically is performed at a temperature from 120° C. to 300° C., although optimum operating temperatures can be selected depending upon the melting point; melt viscosity, and thermal stability of the composition. Different types of melt processing equipment, such as extruders, may be used to process the melt processable compositions of this invention. Extruders suitable for use with the present invention are described, for example, by Rauwendaal, C., “Polymer Extrusion,” Hansen Publishers, p. 23-48, 1986, which pages are incorporated herein by reference.

The melt processable compositions may be utilized to make foamed items such as building materials and automotive components. Non-limiting examples include, residential decking, automotive interior components, roofing, siding, window components, and decorative trim. The foamed composite material may be prepared and have the compositions as described in U.S. patent application Ser. No. 11/284,414, entitled “Foaming Additives,” filed on Nov. 21, 2005, which is hereby incorporated herein by reference in its entirety.

### EXAMPLES

The following example is provided to further describe the subject matter disclosed herein. The example should not be considered as being limiting in any way.

TABLE 1
Materials

| Material | Description |
|---|---|
| PP | HB 1602 12 MFI polypropylene commercially supplied by BP |
| | (Warrenville, IL) |
| Wood Fiber | 40 mesh hardwood fiber commercially available from American |
| | Wood Fibers (Schofield, WI) |
| Aspen Bark Pellets | Commercially available from Lone Tree Manufacturing (Bagley, |
| | MN) |
| Birch Bark | Collected from birch trees in Northern, MN. |
| Betulin | Birch Bark extract, commercially available from NaturNorth LLC |
| | (Duluth, MN) |
| Borogard ZB | Zinc Borate, Commercially available from Borax Inc. (Wilmington, |
| | DE) |

### Preparation of Examples 1-5

Composite samples were prepared and tested using the following protocol. Wood fiber was pre-dried for 4 hours at 93.3° F. in a vacuum oven at less 0.1 mmHg. Resin (PP), wood fiber and additives (i.e., antimicrobial materials such as aspen bark, birch bark, betulin, and/or Borogard ZB) were then dry mixed in a plastic bag and gravity fed into a 27 mm co-rotating twin screw extruder fitted with a 0.64 cm×7.62 cm profile die (commercial available from American Leistritz Extruder Corporation, Sommerville, N.J.). All samples were processed at 50 rpm screw speed using the following temperature profile: Zone 1-2=150° C., Zone 3-4=160° C., Zone 5-6=180° C., Zone 7-8=190° C. The samples were extruded and subsequently quenched in cold water. The samples were then steam sterilized and subsequently tested for resistance to brown and white rot fungi following ASTM G21 (or ASTM D1413), both of which are incorporated by reference herein in their entireties.

Table 2 shows the formulations of the samples that were produced. As shown in Table 2, two comparative samples (CE 1 and CE 2) were prepared where one did not include any antimicrobial material and the other one included a non-naturally occurring antimicrobial material. Table 3 shows the antimicrobial resistance of the composite formulations shown in Table 2.

TABLE 2
Composite Formulations

| | | | Aspen Bark | | | |
|---|---|---|---|---|---|---|
| | Polypropylene | Wood Fiber | Pellets | Birch Bark | Betulin | Borogard ZB |
| Example | (wt %) | (wt %) | (wt %) | (wt %) | (wt %) | (wt %) |
| CE1 | 60 | 40 | — | — | — | — |
| CE2 | 56 | 40 | — | — | — | 4 |
| 1 | 60 | — | 40 | — | — | — |
| 2 | 59 | 40 | — | 1 | — | — |
| 3 | 55 | 40 | — | 5 | — | — |
| 4 | 59 | 40 | — | — | 1 | — |
| 5 | 58 | 40 | — | — | 2 | — |

TABLE 3
Microbial Resistance

| Example | Replicate 1 | Replicate 2 | Replicate 3 | Average |
|---|---|---|---|---|
| CE 1 | 4 | 4 | 4 | 4 |
| CE 2 | 0 | 0 | 0 | 0 |
| 1 | 1 | 0 | 0 | 0.3 |
| 2 | 3 | 3 | 3 | 3 |
| 3 | 3 | 4 | 3 | 3.33 |
| 4 | 3 | 2 | 3 | 2.67 |
| 5 | 3 | 3 | 3 | 3 |

### Preparation of Examples 6-19

Additional composite samples were prepared and tested using the following protocol. Resin (PP/HDPE), wood fiber, and the additives (i.e. antimicrobial materials such and the aspen bark, birch bark, betulin, and/or Borogard ZB) were then dry mixed in a plastic bag and gravity fed into a 27 mm co-rotating twin screw extruder fitted with a 1.27 cm×7.62 cm profile die (commercially available from American Leistritz Extruder Corporation, Sommerville, N.J.). All samples were processed at 100 rpm screw speed using the following temperature profile: Zone 1-2=150° C., Zone 3-4=160° C., Zone 5-6=180° C., Zone 7-8=190° C. The samples were allowed to cool to room temperature then sent to the Atlas Material Testing Solutions site in south Florida for outdoor weathering exposure. Weathering exposure was based on ASTM G7-05 and ASTM G147-02 protocol, in which the samples were positioned vertically 26° north facing at a tilt angle of 90°. Evaluation of the degree of surface disfigurement was determined by ASTM D3274-95.

Table 4 outlines the samples that were produced (both a sanded and unmarred samples were submitted for testing). Table 5 shows the fungal/microbial resistance based on the D3274-95 ASTM standard (scale is from 1-10 with 10 signifying no growth). The samples containing Betulin exhibited very good fungal/microbial resistance.

TABLE 4
Composite formulations

| | PP | HDPE | Aspen Bark | Aspen wood | Maple wood | Betulin | Zinc |
|---|---|---|---|---|---|---|---|
| Example | % | % | % | % | % | % | borate % |
| 6 | 50 | — | 50 | — | — | — | — |
| 7 | 59 | — | 40 | — | — | 1 | — |
| 8 | 60 | — | 40 | — | — | — | — |
| 9 | 59 | — | — | 40 | — | 1 | — |
| 10 | 60 | — | — | 40 | — | — | — |
| 11 | 59 | — | — | — | 40 | 1 | — |
| 12 | 59 | — | — | — | 40 | — | 1 |
| 13 | — | 50 | 50 | — | — | — | — |
| 14 | — | 59 | 40 | — | — | 1 | — |
| 15 | — | 60 | 40 | — | — | — | — |
| 16 | — | 59 | — | 40 | — | 1 | — |
| 17 | — | 60 | — | 40 | — | — | — |
| 18 | — | 59 | — | — | 40 | 1 | — |
| 19 | — | 59 | — | — | 40 | — | 1 |

TABLE 5
Fungal/microbial resistance

| Example | Rating of Unmarred Sample | Rating of Sanded Sample |
|---|---|---|
| 6 | 10 | 9 |
| 7 | 10 | 7 |
| 8 | 9 | 10 |
| 9 | 10 | 10 |
| 10 | 9 | 10 |
| 11 | 10 | 8 |
| 12 | 10 | 7 |
| 13 | 9 | 8 |
| 14 | 10 | 10 |
| 15 | 8 | 9 |
| 16 | 10 | 10 |
| 17 | 10 | 10 |
| 18 | 10 | 10 |
| 19 | 10 | 10 |

### Illustrative Embodiments

Reference is made in the following to a number of illustrative embodiments of the subject matter described herein. The following embodiments illustrate only a few selected embodiments that may include the various features, characteristics, and advantages of the subject matter as presently described. Accordingly, the following embodiments should not be considered as being comprehensive of all of the possible embodiments. Also, features and characteristics of one embodiment may and should be interpreted to equally apply to other embodiments or be used in combination with any number of other features from the various embodiments to provide further additional embodiments, which may describe subject matter having a scope that varies (e.g., broader, etc.) from the particular embodiments explained below. Accordingly, any combination of any of the subject matter described herein is contemplated.

According to one embodiment, an microbial resistant composite comprises: a polymeric matrix or polymeric material; and a naturally occurring antimicrobial material. The polymeric matrix may include a polyolefin such as polyethylene or polypropylene. The naturally occurring antimicrobial material may include birch bark, extracts from birch bark, aspen bark, extracts from aspen bark, betulin, or mixtures thereof.

In another embodiment, an microbial resistant composite comprises: a polymeric matrix; a filler; and a naturally occurring antimicrobial material. The polymeric matrix may comprise a polyolefin such as polyethylene or polypropylene. The filler may comprise a cellulosic material such as wood fiber. The naturally occurring antimicrobial material may comprise aspen bark.

In another embodiment, a method for producing a microbial resistant composite may comprise melt processing a mixture that includes a polymeric matrix and a naturally occurring antimicrobial material. The melt processing may be performed by extrusion, injection molding, batch mixing, blow molding and rotomolding. The method may be used to prepare microbial resistant composites for use as building materials and automotive components.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. The subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

1. A microbial resistant composite comprising:
a polymeric matrix;
a tree bark extract that is antimicrobial.

2. The microbial resistant composite of claim 1 comprising a filler.

3. The microbial resistant composite of claim 1 comprising a cellulosic material.

4. The microbial resistant composite of claim 1 wherein the polymeric matrix comprises a polyolefin.

5. The microbial resistant composite of claim 1 wherein the polymeric matrix comprises polyethylene and/or polypropylene.

6. The microbial resistant composite of claim 1 comprising about 1 to 5 wt. % of the tree bark extract.

7. The microbial resistant composite of claim 1 wherein the tree bark extract includes betulin.

8. The microbial resistant composite of claim 1 comprising no more than about 5 wt. % of the tree bark extract.

9. The microbial resistant composite of claim 1 comprising at least about 30 wt. % of the polymeric matrix.

10. The microbial resistant composite of claim 1 wherein the microbial resistant composite is foamed.

11. The microbial resistant composite of claim 1 wherein the microbial resistant composite includes a plurality of voids filled with gaseous material.

12. The microbial resistant composite of claim 1 wherein the tree bark extract includes extract of aspen bark, birch bark, and/or poplar bark.

13. The microbial resistant composite of claim 1 wherein the tree bark extract includes an extract of birch bark.

14. A microbial resistant composite comprising:
a polymeric matrix which includes polyethylene and/or polypropylene; and
an extract of aspen bark, birch bark, and/or poplar bark that is antimicrobial.

15. The microbial resistant composite of claim 14 wherein the extract includes an extract of birch bark.

16. The microbial resistant composite of claim 14 wherein the extract includes betulin.

17. The microbial resistant composite of claim 14 comprising a filler.

18. The microbial resistant composite of claim 14 comprising a cellulosic material.
